(19) United States
(12) Patent Application Publication
(10) Pub. No.: US 2004/0066782 A1
(43) Pub. Date: Apr. 8, 2004

(54) System, method and apparatus for sharing and optimizing packet services nodes

(76) Inventor: Ayman Esam Nassar, Clarksville, MD (US)

Correspondence Address: AYMAN NASSAR, P.O. BOX 726, CLARKSVILLE, MD, 21029, US

(21) Appl. No.: 10/667,869

(22) Filed: Sep. 22, 2003

Related U.S. Application Data
(60) Provisional application No. 60/412,685, filed on Sep. 23, 2002.

(51) Int. Cl. H04L 12/56; H04L 12/28

(52) U.S. Cl. 370/389; 370/400; 370/419

(57) ABSTRACT

A dedicated, optimized, secure and private apparatus, system and method is provided for service providers to dynamically share the resources of a single packet services node within a telecommunications network. The apparatus, method and system uses real-time dynamic software partitioning, with low-level dynamic hardware reconfiguration and adaptation, to enable real-time network, software and hardware resource allocation. The packet services node is configured as a unified and integrated switch (UIS) that can be segmented into a number of logical communication nodes (LCN). Each LCN operates as a secure, independent, private and dynamically configured packet services node. A master controller is responsible for the allocation of resources to LCNs based on resource availability and/or a predefined resource allocation configuration between the operator of the UIS and the user of the LCN.

### CROSS-REFERENCED TO PRIOR APPLICATIONS

This application claims the benefit of U.S. Provisional Application Serial No. 60/412,685 filed Sep. 23, 2002.

### BACKGROUND OF THE INVENTION

1. Technical Field of the Invention

The present invention relates to the field of telecommunications, specifically the transport and processing of optical and electrical packetized data, voice, and video. It also relates to the optimization of telecommunication resources between two or more different administrative domains.

2. Description of Related Art

Service providers have been struggling to find means to reduce operational and capital expenses, and improve revenue streams. These challenges have been magnified by the explosive growth in Internet traffic resulting in an exponential demand for Internet Protocol (IP) networks and its services. This has put more pressure than ever on service providers to bring in additional revenue from their networks, reduce costs of operating the network and minimize capital expenses. Additionally the fact that access services and backbone transit have emerged to become low-margin commodity services has compounded the problem even further.

Sharing of network resources such as infrastructure nodes can provide a means to achieve these goals. By developing a method and system that allows service providers to share network nodes securely and privately, service providers become able to establish strategic partnerships and alliances with their competitors without sacrificing critical confidential information regarding network configurations, subscriber profiles and information, service offerings, demand and other private information. Sharing provides the service provider, the end user, the regulator, and the equipment supplier with many economic benefits.

Network infrastructure sharing is a means to reduce capital expenses, and operational expenses in addition to achieving higher revenue streams. Those most interested in network node sharing are wireless service providers, long haul providers, and broadband service providers that have been under the burden of huge capital costs in the form of wireless spectrum licensing fees, undersea and terrestrial cable deployment, and facilities build-outs. These costs are in the order of several billions of dollars for a single provider, and it is estimated that it would typically require a service provider an average of almost 10 years to recoup these huge investments. Sharing network infrastructure and resources allows service providers to achieve quicker deployments and time to market, saves capital, and provides means to expand service offerings into a region without huge overhead of building the facilities and network access. Benefits are also realized by the suppliers in the form of quicker orders, more orders and reduced risk. Subscribers gain access to more choices of services and earlier service availability in a geographical location. Sharing network infrastructure satisfies the requirements of regulators by increasing competition between service providers, reducing environmental concerns, and providing service providers with avenues for introducing new revenues and fair share of the market.

Conventional technology used in Internet infrastructure nodes is based on a fixed, static apparatus architecture. Conventional packet services nodes, such as routers and switches, have been based on a single operating system with a centralized control processor and distributed traffic processors. Recent contributions to technology have introduced the concept of virtual routers (VR), virtual routing and forwarding instances (VRF), and virtual context to offer virtual private network (VPN) services.

VRF and virtual context are based on the idea of virtualizing a routing table, by sharing the memory space provisioned and controlled by a wholesale or upstream service provider among multiple virtual private networks (VPNs), each VPN with its own routing table. While VRF offers the ability to achieve VPN services, it lacks the ability to provide a VPN user (site) full access to the configuration of the VPN resources, such as hardware and software resources. In addition, no physical hardware resources are assigned to the services of a particular VPN, other than a logical channel on the physical line card port. Therefore, a VPN user of a virtual routing table also lacks security and privacy.

Another virtual routing method currently in use allows a service provider to virtually slice a physical port among multiple customers. This allows a service provider to share physical resources on a router node among two or more customers. These protocols, which are also known as VPN protocols, operate at the network layer 3 level or the network layer 2 level, and there are currently proposals for optical VPNs as well. Examples of these methods are discussed in BGP-VPNs (Internet Engineering Task Force (IETF) Request for Comments (RFC) 2547, and in IETF RFC 2764 which are hereby incorporated by reference. These methods are based on Virtual Routers, and port based VPNs. However, these methods are unsuitable for a network access point (NAP) environment due to the lack of privacy, lack of security, and lack of ability of the service provider using a virtual router, virtual partition, or virtual port to have full control on these virtual instances. Instead, only the operator of the node has access to configure and provision the virtual instance. Additionally, the user of the virtual instance cannot customize the virtual instance being leased or used from the service provider managing the node, due to the presence of shared hardware and other software components.

Other virtual router (VR) concepts have also been developed, an example of which is U.S. Pat. No. 5,550,816, which is hereby incorporated by reference. However, there are several drawbacks to such other VR concepts, such as the inability to provide the user of a virtual router with full control on the virtual router, with respect to its resources, processes, configuration, management and services running, such as routing protocols.

### SUMMARY OF THE INVENTION

To overcome deficiencies of the prior art, embodiments of the present invention provide a dedicated, optimized, secure and private apparatus, system and method for service providers to dynamically share the resources of a single packet services node within a telecommunications network. The apparatus, method and system uses real-time dynamic software partitioning, with low-level dynamic hardware reconfiguration and adaptation, to enable real-time network, software and hardware resource allocation.

In one embodiment of the invention, the packet services node is a unified and integrated switch (UIS) that can be segmented into a number of logical communication nodes (LCN) and a master communication node (MCN). Each LCN operates as a secure, independent, private and dynamically configured packet services node. The master communication node is a master controller is responsible for the allocation of resources to LCNs based on resource availability and/or a predefined resource allocation configuration between the operator of the UIS and the user of the LCN, which can be, for example, one of a plurality of service providers. The UIS receives control and signaling information from other remote nodes on the network and processes that information to build registries of information about network resources and their availability for use in dynamically configuring the LCNs. Additionally, the UIS maintains its own registry of UIS resource availability and attributes, including all the LCN hardware and software resources, to allow node resource optimization and dedicated utilization.

In one implementation embodiment of the invention, the UIS includes a chassis with a set of hardware subsystems that are installed in the chassis. Each of the hardware subsystems provides a specific set of functionalities relating to traffic processing, signaling processing, security management, traffic switching and forwarding, information processing, information storage, traffic and signaling transmission and reception. The hardware subsystems are operated by a real time operating system running a plurality of applications.

In one configuration embodiment of the invention, the UIS includes a plurality of real-time operating systems, each operating and managing the resources of an LCN, and a master controller based on a real-time operating system controlling the overall UIS. The UIS further provides external interfacing to other nodes on the network. The UIS can be used to replace a large number of nodes in a Network Access Point (NAP), wholesale service provider meet-me-room (MMR) or telecom hotel, or the UIS can be used as a shared node in a point-of-presence (POP).

In another configuration embodiment, only a single LCN is configured, and the master controller is disabled. This configuration could be used in the case of a single service provider using the UIS. In yet another configuration embodiment of the invention, a plurality of LCNs are configured and the master controller is disabled, such as the case where the UIS is shared among a number of providers in a POP, and one of the service providers is the operator of the UIS. In still another configuration embodiment of the invention, a plurality of LCNs is configured and the master controller is disabled, such as the case where the UIS is shared among a number of providers in a POP, and one of the service providers is the operator of the UIS, and the other providers sharing the UIS do not wish a competitor to control the overall UIS.

Advantageously, this integrated platform coupled with the ability to interface and process standard protocols creates a unified architecture that realizes and achieves the goals and requirements of reducing operating and capital expenses with the ability to offer a dedicated, optimized, secure and private shared packet services node. The dynamic low-level hardware partitioning further provides the ability to customize operational requirements for quality of service, network traffic processing and control.

### BRIEF DESCRIPTION OF THE DRAWINGS

The disclosed invention will be described with reference to the accompanying drawings, which show important sample embodiments of the invention and which are incorporated in the specification hereof by reference, wherein:

FIGS. 1A, 1B and 1C illustrate the architecture of a prior art NAP, MMR and telecom hotel respectively, including multiple packet service nodes;

FIGS. 2A and 2B are diagrams illustrating prior art methods of supporting multiple providers on the same packet services node through the use of virtual routing instances and multi-routers respectively;

FIG. 3 illustrates the architecture of a prior art shared POP;

FIG. 4 illustrates a unified and integrated switch, in accordance with embodiments of the invention;

FIG. 5A illustrates an exemplary physical embodiment of the UIS;

FIG. 5B illustrates a block diagram of the traffic processing board of the UIS;

FIG. 5C illustrates a block diagram of the line board of the UIS;

FIG. 5D illustrates an exemplary block diagram of the UIS;

FIG. 6 illustrates an exemplary configuration embodiment of the UIS;

FIG. 7 illustrates an exemplary configuration embodiment of the UIS in a NAP scenario;

FIG. 8 illustrates an exemplary configuration embodiment of the UIS in a POP scenario;

FIG. 9 illustrates an exemplary network architecture in accordance with embodiments of the invention;

FIG. 10 is a flow diagram illustrating exemplary steps for the interaction between the retail service provider and wholesale service provider, in accordance with embodiments of the present invention;

FIG. 11 is a flow diagram illustrating exemplary steps of the service requisition phase, in accordance with embodiments of the present invention;

FIG. 12 is a flow diagram illustrating exemplary steps of the service processing phase, in accordance with embodiments of the present invention;

FIG. 13 is a flow diagram illustrating exemplary steps of the service fulfillment phase, in accordance with embodiments of the present invention; and

FIG. 14 is a flow diagram illustrating exemplary steps of the service conclusion phase, in accordance with embodiments of the present invention.

### DETAILED DESCRIPTION OF THE EXEMPLARY EMBODIMENTS

The numerous innovative teachings of the present application will be described with particular reference to the exemplary embodiments. However, it should be understood that these embodiments provide only a few examples of the many advantageous uses of the innovative teachings herein. In general, statements made in the specification do not necessarily delimit any of the various claimed inventions. Moreover, some statements may apply to some inventive features, but not to others.

The following definitions are used in reference to the accompanying description:

SERVER is a device hosting an application acting as application server, a device storing data acting as an information repository, or a device providing the end user with a service through the execution of one or more processes on the device.

RETAIL SERVICE PROVIDER is a service provider that sells services to an end user. The end user could be an enterprise or a residential subscriber. Examples include, but are not limited to, local communication companies, ISPs, phone companies, broadband providers, large enterprises, government agencies, content providers, and wireless providers.

WHOLESALE SERVICE PROVIDER is a service provider that sells services to other service providers. Examples include, but are not limited to, network service providers, Competitive Local Exchange Carriers (CLECs), Regional Bell Operating Companies (RBOCs), Public Telephone and Telegraph (PTTs), Clearing Houses, (CH), Network Access Points (NAPs), Collocation centers, Telecom Hotels, Peering Points, Global Wireless Providers, Global Capacity Providers, Content Providers, and wholesale division of retail service providers.

OPERATOR is a service provider that operates a network, or parts of a network, or a business entity that is responsible for the management, administration, maintenance, troubleshooting and configuration of a network, parts of a network, a node or parts of a node.

SERVICE PROVIDER is a business entity that provides telecomm and datacomm services to another business entity or individual end user.

DATACOM is Data Communications between two or more end points. Communications could in the form of signaling, traffic flow, applications interaction, and/or data transfer.

NEXT GENERATION NETWORK is an electrical or optical packet-based network.

PARTITION is a dedicated, private and secure portion of hardware and software resources assigned to a single service provider. Partitions could be configured statically or dynamically. Partitions could also be adaptive and reconfigurable.

ADAPTIVE PARTITION is a partition whose characteristics and performance vary and change according to demand and availability of network and node resources based on control information received from the network and devices on the network, or received from the UIS controller.

Interconnection between retail service providers (RSP) has taken a number of different forms, depending on the telecom service exchanged between these retail service providers. In the case of an Internet Protocol (IP) RSP, the RSP is an Internet Service Provider (ISP). ISPs typically interconnect at network access points (NAPs).

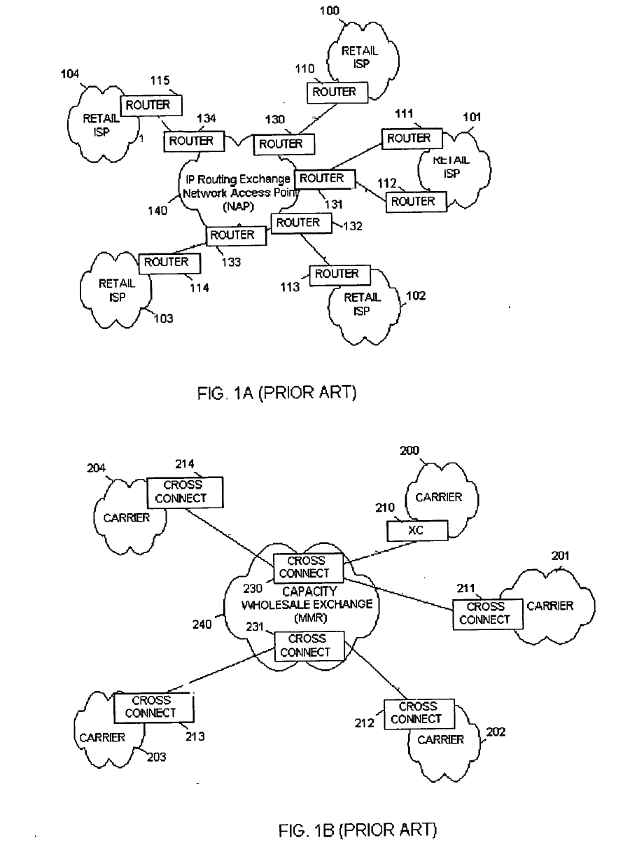

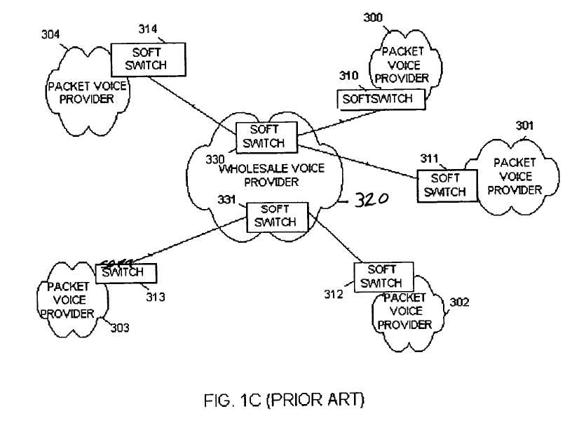

FIG. 1A illustrates a prior art interconnection architecture between ISPs using a NAP as a peering point. An example of a peering point is the MAE-East located in Vienna, Va., 22182, Reston, Va. 20191, and Ashburn, Va. 20147. MAE-East is one of a number of public NAPs, and is operated by WorldCom of 500 Clinton Center Drive, Clinton, Miss. 39056, USA. At peering points, such as NAPs, ISPs exchange routing information services, and provide traffic termination and transit services for other ISPs. Others examples of NAPs are private NAPs (PNAP), such as the NAP of Americas (NOTA) located at 50 NE 9th Street Miami, Fla. 33132. These private NAPs serve as IP routing peering points. Each ISP orders a physical transport from the local service provider in the location of a NAP, between the ISPs nearest point of presence (POP) and the PNAP.

In FIG. 1A, a group of ISPs 100-104 interconnect at a set of routers 130-134, respectively, installed at NAP 140. Routers 130-134 are owned, administered and operated by ISPs 100-104, respectively. ISPs 100-104 connect to NAP 140 using routers 110-115, respectively, which are connected to routers 130-134, respectively. For example, router 110 is owned, operated and administered by ISP 100 and is located on the premises of ISP 100 at a POP connected to NAP 140 using router 130. The operator of NAP 140 allows each service provider 100-104 to install a router 130-134, respectively, at the NAP's physical premise and connect each of routers 130-134 to a LAN switch (not shown) located at NAP 140 that interconnects all ISP routers to one another.

A number of issues exist with the NAP model and architecture presented in FIG. 1A. First, the NAP model requires the retail service provider to pay for the cost of a router to be remotely installed at the NAP or PNAP. In the case presented in FIG. 1A, ISPs 100-104 need to install, operate, administer and secure at least one router at every NAP they wish to connect to. Second, the operator of the NAP has a fixed revenue model based on leasing physical space to each of the ISPs 100-104 to host their routers 130-134, respectively, in a physically secure environment. The revenue the NAP operator realizes is independent of the amount, type, value or quality of traffic being exchanged at the NAP. The costs of operating the NAP also increase as the number of ISPs increase by a factor of N, where N equals the number of ISPs connected to the NAP. It is clear that N providers peering together require at a minimum N routers and N times the power consumption, physical space and cooling requirements at the NAP. These issues altogether exist in both a public and a private NAP.

FIG. 1B shows the architecture of a capacity meet-me-room (MMR), where a number of RSPs, termed voice carriers 200-204, interconnect at wholesale service provider (WSP) 240 premises. WSP 240 installs and operates a number of cross connects 230-231. Each voice carrier 200-204 connects to the WSPs network by connecting the voice carriers' cross connect, multiplexer or switch 210-214, respectively to one of the WSPs cross connects 200 or 231.

FIG. 1C shows a voice telecom hotel where packet voice providers 300-304 interconnect at a wholesale voice provider 320. The interconnection of the packet voice providers 300-304 occurs at a voice soft switch 330-331 via soft switches 310-314, respectively. Interconnection services illustrated in FIG. 1B and FIG. 1C suffer from the same limitations as the IP routing interconnection service illustrated in FIG. 1A.

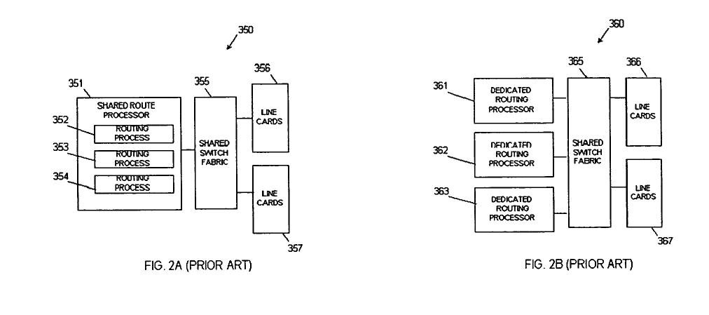

FIG. 2A illustrates a prior art packet services node 350, such as an IP router that includes a shared route processor 351 shared by the three different virtual private networks (VPN) configured on node 350. Each of these three VPNs requires a routing process. Route processor 351 hosts a number of routing processes 352-354, each representing a VPN. The shared route processor 351 is connected to line cards 356 and 357 using a switch fabric 355, which is shared by all three VPNs. Each port (not shown) on line cards 356 and 357 is mapped and virtually connected to one of the routing processes 352-354.

FIG. 2B represents another prior art approach. In this case, a packet services node 360 includes three independent routing processors 361-363. Each of the dedicated routing processors 361-363 is connected to the line cards 366 and 367 through a shared switch fabric 365. The approach illustrated in FIG. 2B is based on using multiple routers, which reduces the operational cost of the NAP operator and the capital expenses of the retail ISP. Several hardware components of the system are shared among all the virtual routers, which affects the ability to customize the environment of each service provider using a multi-router. However, the approach illustrated in FIG. 2B does not address the issue of a fixed revenue model, as that NAP operator will only be capable of offering IP routing, and hence is limited to the leasing of the virtual router to an ISP. Therefore, support for multiple types of media services cannot be achieved, due to the lack of critical components, such as multiple RTOS in each multi-router or routing processor which can enable the support of different types of application modules leading to the realization of a router, optical switch or media soft switch or any combination of each on a per retail service provider basis.

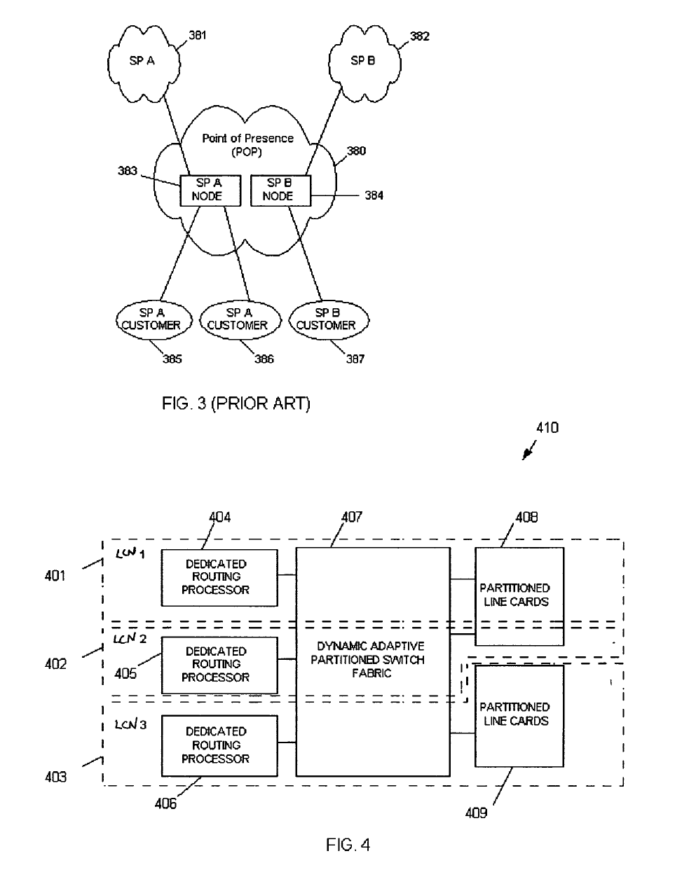

FIG. 3 illustrates a prior art architecture of a network POP 380. In this case, two service providers 381 and 382 share the physical facilities of the POP 380, such as the building, the power feeds, and cooling systems. Each provider 381 and 382 installs its own packet services node 383 and 384, respectively at the POP 380. The packet services nodes 383 and 384 can be IP routers, voice soft switches or optical switches. The disadvantage of the prior art POP architecture is an N factor increase in power consumption, physical space, and cooling requirements for N number of service provider nodes in a shared POP facility. In addition to a higher cost per provider using the POP, this higher cost is in the form of equipment capital expenditures.

In sum, the prior art lacks the capability to allow each service provider sharing a node to customize it to meet and suit its specific needs. For example, consider the case where one service provider markets packetized voice services that require low jitter, low delay and high priority service, while another provider markets leased line services for bulk data transfers that are delay insensitive. Each one of these service providers will require a different QoS configuration of its node. The prior art does not allow each provider to customize its own congestion management, queuing and scheduling systems, nor does it allow the service provider full access to the partition the provider leases from the operator of the node. The prior art also lacks privacy and security, since all information that is related to a VPN or VR on a packet services node is available to the operator of the node. If the operator of the node is a service provider also sharing the resources of the node, that could introduce a security and privacy threat to the other service providers utilizing the node.

In accordance with embodiments of the present invention, packet services nodes can be reconfigured as unified and integrated switches (UIS) that use a master controller to manage and supervise the provisioning of logical communication nodes (LCNs), each being associated with a different service provider (e.g., RSP or WSP). Each UIS is a single physical packet service node. The LCN is the result of two processes, the first being a logical partitioning process resulting in the formation of a RTOS virtual machine and applications running on the RTOS. The second process is the low-level hardware partitioning that allocates specific hardware resources such as processors, traffic managers, memory, hard disk space or portions of a common hardware subsystem such as a switch fabric on an as needed basis to LCNs. The dynamic nature of the switching element reconfiguration allows it to be broken down into a number of smaller switch fabrics, each serving and switching traffic within the LCN. LCNs are separated from one another by a stateful firewall that could be implemented in hardware using ASICs to realize traffic and control filters, or in software as an application and controlled by the RTOs.

FIG. 4 illustrates an exemplary UIS 410 implementing a dynamic adaptive dedicated hardware partitioning concept, in accordance with embodiments of the present invention. The exemplary packet based network node 410 includes a plurality of LCNs 401-403. Each LCN, for example LCN 401, includes a dedicated routing processor 404 and a portion of switch fabric 407 dedicated only to the use of the service provider using LCN 401. Furthermore, a portion of a line card 408 is assigned to LCN 401. LCN 402 includes routing processor 405, a dedicated portion of fabric 407 and portion of line card 408. LCN 403 includes a dedicated routing processor, a portion of switch fabric 407 and the whole of line card 409. In other configuration embodiments, one or more of the LCNs 401-403 could be configured to include a plurality line cards. The portion of the switch fabric 407 assigned to each LCN 401-403 is fully dedicated to the usage of that particular LCN 401-403 and becomes detached from the rest of switch fabric 407, which allows the user of a LCN 401-403 to customize the configuration of the partitioned and dedicated portion of switch fabric 407.

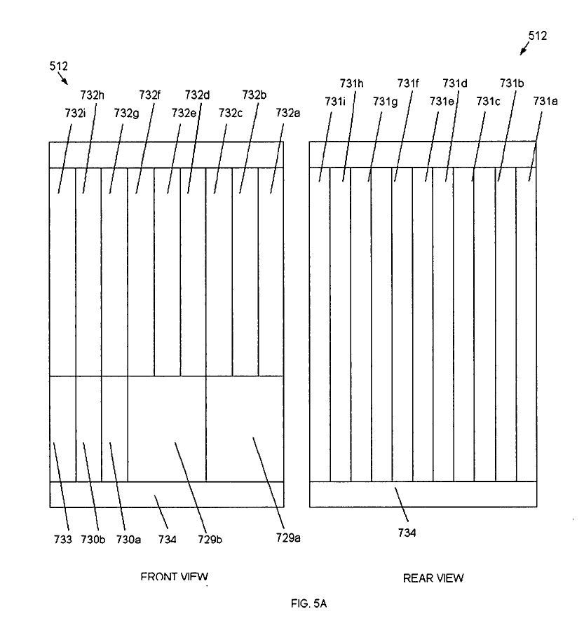

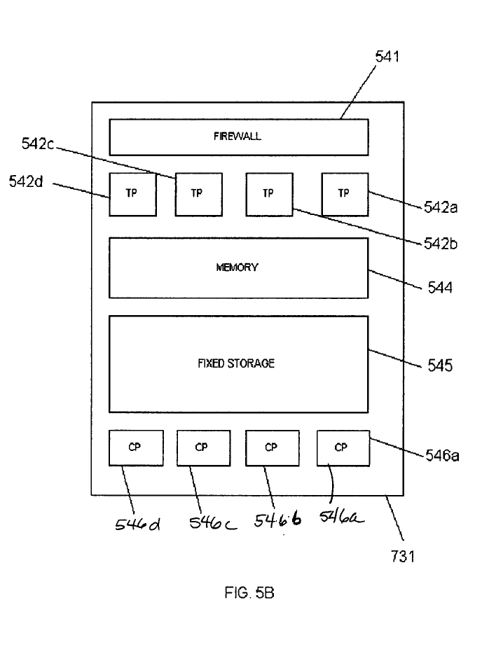

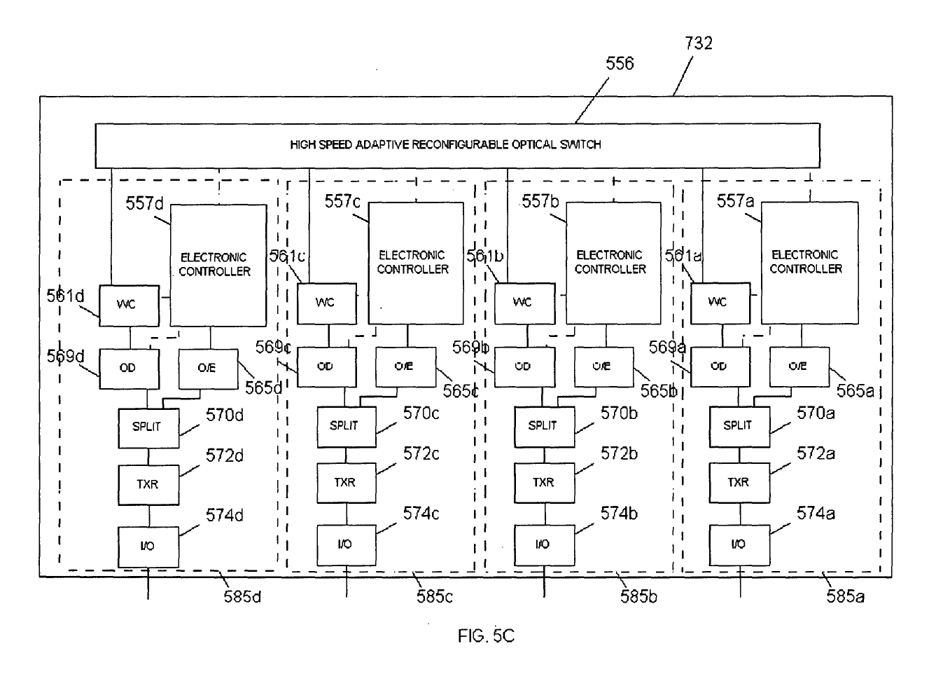

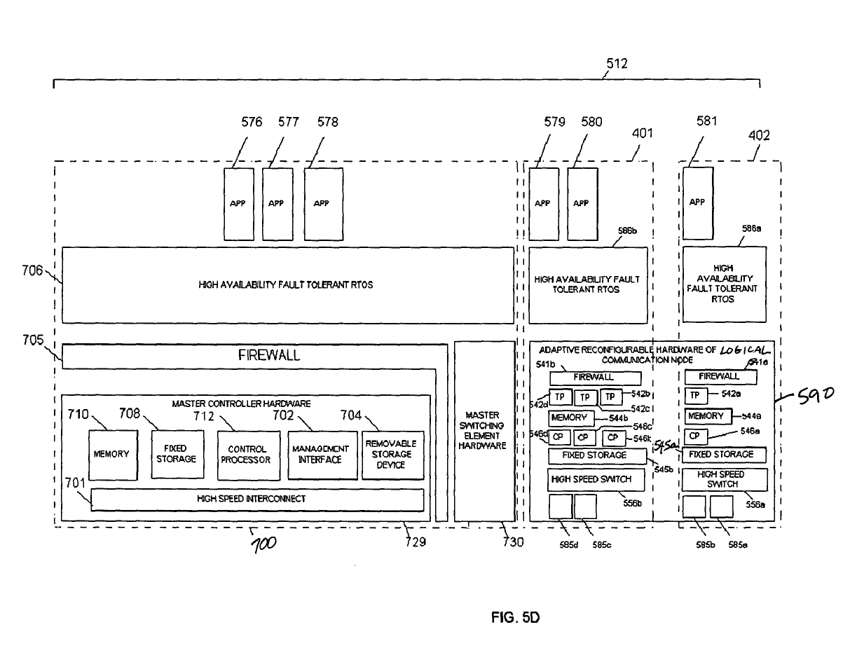

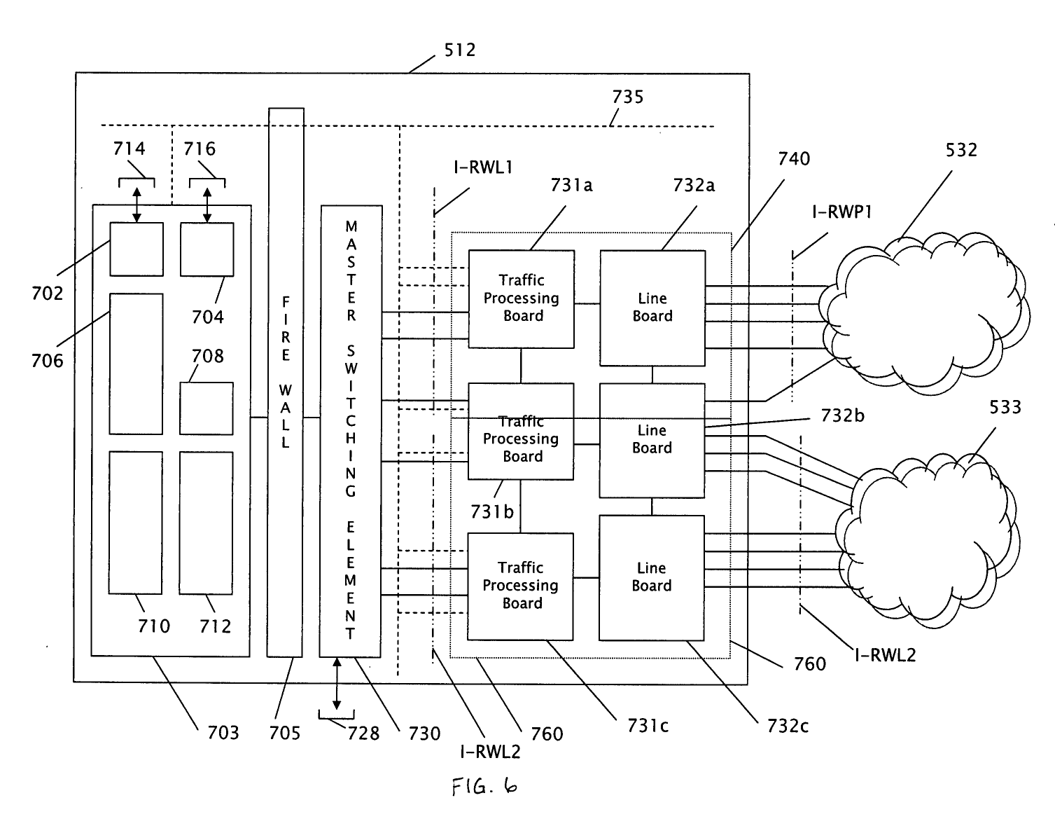

FIG. 5A illustrates one exemplary physical embodiment of the UIS 512 of the present invention. The UIS 512 includes a set of fans 734, primary and secondary master controller boards 729a and 729b, respectively, primary and secondary master switching element boards 730a and 730b, respectively, a plurality of traffic processing boards 731a-731i, a plurality of line boards 732a-732i, and power supplies 733.

Referring to FIG. 5B, the traffic processing board 731 includes a firewall 541, a plurality of traffic processors 542a-542d, memory 544, fixed storage 545, and a plurality of control processors 546a-546d. In the example shown in FIG. 5B, four traffic processors 542a-542d, and four control processors 546a-546d are shown. However, it should be understood that any number of traffic or control processors could be implemented and configured. Traffic processors 542a-542d provide processing of network traffic packets, a few exemplary functions are packet classification, compression, packet field information lookup and processing and others. The traffic processors are assigned to one or more than one LCN based on control information received and process by the MCN. In the exemplary traffic board 731 shown in FIG. 5B, traffic processors 542a-542b could be assigned and configured to be dedicated to an LCN; and traffic processors 542c could be assigned and configured to be dedicated to a second LCN; and traffic processor 542d can be assigned and configured to a third LCN. Firewall 541 provides security and privacy services, examples are anti-hacking, separation between LCNs and each other, and isolation of the LCN's resources from other LCNs. The firewall also controls the flow of network and LCN control information into and outside of the LCN. Control processors 542a-542d provide processing of network signaling and control information such as routing updates, resources reservation signals, switching information and other similar types of network control information. Similar to the traffic processors, the control processors could be dynamically assigned to a plurality of LCNs based on the information possessed by the MCN. The number of control processors assigned and dedicated to a particular LCN can be the same as or different from the number of traffic processors assigned to the same LCN. Memory 544 is used to store network traffic and other network information during control signal and network traffic processing.

Referring to FIG. 5C, the architectural diagram of line board 732 is illustrated. Line board 732 includes components that perform the layer 1 and layer 2 processing, a plurality of input/output ports and interfaces 574a-574d, a plurality of transceivers 572a-572d, a plurality of optical splitters 570a-570d, optical/electrical converters 565a-565d, optical delays 569a-569d, electronic controllers 557a-557d, wavelength converters 561a-561d, and a high speed optical switching element 556. For illustrative purposes only the number of ports in the illustration in FIG. 5C is four. However, it should be understood that any number of ports equal to or more than one can be used. Each port can also accept one or more than one wavelength. In the case of more than one wavelength, extra sets of the same components will be required to process additional wavelengths. Line board 732 can also be an electrical-only board, which would only include electrical controllers 557a-557d.

The architecture described in FIGS. 5A-5C allows each retail service provider to have full control over its LCN. In addition, each of the retail service provider operators can configure their partition themselves and have a dedicated, private and secure, physical out-of-band connection into their partition. Furthermore, each retail service provider can have the partition act as a different type of packet services node, adding and removing hardware components to it dynamically and adaptively, with the ability to customize the hardware and software components of the partition, thereby creating a logical communication node within the platform. The partition can also provide various functions, and not only a traditional IP routing function, due to the fact that a LCN supports unified protocols, such as unicast and multicast IP routing protocols, switching protocols such as Asynchronous Time Multiplexing (ATM) and Generalized Multiprotocol Label Switching (GMPLS), optical control protocols such as Link Management Protocol (LMP) and protocols such as Session Initiation Protocol (SIP) and Resource Reservation Protocol (RASP). These are just an exemplary list of protocols that could be supported on the UIS and the LCNs. For example, one partition could be acting as an Multiprotocol Label Switching (MPLS) Label Edge Router (LER), while another one is performing the functions of a voice call agent or soft switch, while a third could be acting as an optical cross connect or switch. Therefore, the architecture of FIGS. 5A-5C offers the NAP operator the flexibility to provide not only IP routing peering, but also physical interconnection, such as the case of an intelligent meet-me-room (MMR), or voice interconnection services, such as a voice exchange center. In addition, the architecture of FIGS. 5A-5C enables a single UIS to replace all of the routers, cross connects or soft switches in FIGS. 1A-1C.

Referring now to FIG. 5D, the UIS 512 includes a specifically configured LCN 700 that operates as the main communication node and is the master controller of the UIS. The main communication node (MCN) 700 includes real-time OS 706, master controller hardware 729, a master switching element 730 and a plurality of applications 576-578. The master controller hardware 729 includes a high speed interconnect 701, memory 710, fixed storage 708, control processor 712, management interface 702 and removable storage device 704. The MCN 700 is a complete computing and communication machine with the ability to function as a packet services node.

A number of LCNs 401-402 are configured by partitioning the software and hardware resources available for the retail service providers. In one embodiment, hardware is added and removed to and from a virtual machine under zero latency conditions. Considering an exemplary implementation embodiment and referring to FIG. 5C, one can assume that physical hardware line board 732 consists of 4 I/O ports 574a-574d, four transceivers 572a-572d, four optical splitters 570a-570d, four optical/electrical converters 565a-565d, four optical delays 569a-569d, four electronic controllers 557a-557d, four wavelength converters 561a-561d, and a high speed optical switching element 556. All the optical components can be grouped into a logical subsystem 585a-585d, as illustrated in FIG. 5C.

Referring to FIG. 5D a pool of hardware resources 590 and software resources 579-581 are available on UIS 512 to the various LCNs and hence are assigned to each of LCNs 401 and 402. Assuming that network services of an RSP requires the termination of two wave lengths, one on each I/O port, then two blocks of optical subsystems 585c-585d will be required. LCN 401 is assigned to the said RSP and configured to include partial resources of a traffic processing board and partial resources of a line board. Only three traffic processors 542b-542d out of the four on the traffic processor board are required and hence added to LCN 401. In addition, a portion of the memory pool 544b, and only three processors 546b-546d out of the 4 control processors are added to LCN 401. The high speed switch 556 is dynamically programmable to be modified and broken down into a larger number of switching elements each of a smaller switching capacity, according to the switching needs of a LCN. The high speed switching element 556 is partitioned into a smaller switch, to switch traffic locally within the RSP. The partitioned portion is shown in FIG. 5D and identified as 556a in LCN 402 and 556b in LCN 401. Similarly, firewall 541 is partitioned into a larger number of smaller capacity firewalls. In this exemplary configuration, the partitioned portion identified as 541a in LCN 402 and 541b in LCN 401. LCN 401 receives the downloaded applications 579 and 580 from MCN 700. MCN 700 comprises the master controller hardware 729, a master firewall 705, a master switching element 730, a high availability RTOS 706 and a set of applications 576-678 running on the MCN. LCN 402 which is assigned to a different RSP with a different contract with the operator of MCN 700 is downloaded application 581. In one exemplary embodiment of the invention each LCN can have an RTOS dedicated to it such as the case with RTOS 586a-586b for LCNs 402 and 401, respectively, in another embodiment of the invention RTOS 706 can download separate RTOS for each LCN customized for the need of the LCN. Similarly the memory is partitioned into two sets, memory 544a for LCN 402 and 544b for LCN 401. Control processors 546b-546d are assigned and configured to be dedicated to LCN 401, while control processor 546a is assigned and dedicated to LCN 402. Each LCN is also assigned blocks of fixed storage such as 545b and 545a which are dedicated to LCNs 401 and 402, respectively.

FIG. 6 illustrates an exemplary configuration of the hardware architecture of UIS 512. In the exemplary configuration embodiment provided in FIG. 6, two retail service providers 532 and 533 are connected to UIS 512. Physical interfaces I-RWP1 and I-RWP2 exist between the node operator and the retail service provider (RSP). The physical interface I-RWP1 at which the UIS 512 and the RSP 532 connect defines the physical boundary between the UIS 512 and the network of RSP 532. Logical interfaces are also defined between any RSP (users of the LCN) and other service providers, including the operator of UIS 512. In the exemplary configuration embodiment in FIG. 6, logical interface I-RWL1 exists between RSP 532 and the operator of UIS 512, and between RSP 532 and RSP 533. Logical interface I-RWL1 is located within node 512 as noticed in FIG. 6 and defines the control and user plane border between RAP 532 and the operator of UIS 512. I-RWL2 is located within platform 512 and defines the control and user plane border between RSP 533 and the operator of UIS 512.

Referring to FIG. 6, the master controller board 703 encompasses the entire master controller hardware such as management interfaces 702, management port 714, removable storage device 704, interface to other external storage devices or to internal storage device 716, fixed storage 708, memory 710, control processors 712, and a high speed interconnect channel 701 shown in FIG. 5D interconnecting all the hardware components of the master controller board. The master controller board 703 can contain a hardware implementation of firewall 705, or in another embodiment the firewall could be a separate hardware board, or could be a software implementation as discussed earlier. The master controller board 703 also hosts a RTOS 706 and a plurality of other applications 576-578 in FIG. 5D, required to support the functionality of the MCN.

The master switching element 730 performs switching between the different LCNs, in the case of FIG. 6 LCNs 740 and 760. The master switching element could be implemented using any switching technology or shared memory storage or other technology for switching traffic between different points. The master switching element 730 could be implemented as a separate hardware board, or the switching element could be implemented on the master controller hardware board 703.

UIS 512 includes a plurality of LCNs, in the configuration example of FIG. 6, those are LCNs 740 and 760, in addition to a master controller board 703, a master switching element 730, and a control bus 735. It is worth noting the number of LCNs could be any number and not specifically two. Master switching element 730 connects the different LCNs 740 and 760 to one another, and to the master controller board 703 for cases which need data processing by the master controller board 703. The master controller board 703 is also connected to other master controller boards on other UISs located on the network through high speed trunk interfaces 728.

Each RSP connects to the UIS at 2 locations. The first is at an in-band interface, such as physical interface I-RWP1 and I-RWP2. The other location is an out-of band management physical interface 714. Out of band element management interface 714 comprises a plurality of physical ports. Each port connects to a different service provider. The number of ports on interface 714 is equal to or greater than the maximum number of LCNs that could be defined on UIS 512, in addition to at least one extra port for administrative access to the MCN.

Interface 714 allows the operator of UIS 512 to administer, configure, and manage the node. It has a plurality of ports, these ports could provide video output, or could be in the form of an LCD or some other visual display, of which at least one is used by the operator of the platform for management connectivity allowing the platform administrator or operator to administer, configure, and manage the node. The management ports could be an Ethernet port running at 10 Mbps, 100 Mbps or even 1 Gbps, a serial port, a wireless interface supporting a technology such as Bluetooth or 802.11, in addition to interfaces for multiple keyboards and pointing devices.

Remaining ports connected to the interface 714 are used for remote out of band access into the respective LCNs, and are used by RSPs 532 and 533 to connect into their respective logical communication nodes 740 and 760 to perform administration, configuration and maintenance tasks.

Interface 716 allows the operator of the platform, which is typically the wholesale service provider to install software applications or install diagnostic tools using a removable storage device such as a floppy disk, CD-ROM, DVD, magnetic tape media, or other removable storage media.

RTOS 706 acts as a resource manager for the whole UIS. Fixed storage 708 in the form of solid state permanent storage unit such as a hard disk, or a raid array is also available to store any accounting, troubleshooting, logging information or billing information. Fixed storage 708 could be replaced by a remote server on the network. Fixed storage 708 or memory 710 could be used to store copies of applications and services provided to the retail service providers 532 and 533 by wholesale service provider. A single or plurality of processors 712 are part of the master controller board 703, and said processors interface with memory 710 to store real time control information collected from the network. For example, control processor 712 can include a central processing unit (CPU), static RAM (SRAM), cache, controllers, ROM, and clock. Control processor 712 can be considered a complete microprocessor based system, such as a real time server motherboard. Memory 710 can be a large high speed memory pool. Master controller board 703 runs routing software and protocol stacks allowing the platform to participate in the collection and dissemination of routing information and signaling information concerning the networks to which it connects to.

Control bus 735 transfers control information such as routing updates, topology changes, route costs, optimum paths, and many other control information to all configured logical communication nodes 740 and 760. Control bus 735 also transfers control information about requests and services needed by the networks connected to logical communication nodes 740 and 760, between the logical partitions 740 and 760 and the master controller board 703. Control information is also carried on bus 735 between the master controller board 703 and the master switching element 730. This control information allows a dynamic instant configuration of the master switching element 730 to switch traffic between LCNs configured on the UIS such as 740 and 760, in the case of the exemplary configuration in FIG. 6. Control bus 735 also carries the configuration, and maintenance information and commands input by the RSP via management interface 714 to the respective LCN.

FIG. 6 illustrates the hardware architecture and the preferred realization of the UIS, it is illustrated in the case of two LCNs 740 and 760 configured. Three traffic processor boards 731a-731c and three line boards 732a-732c are installed in UIS 512. Resources on the traffic processor boards the line boards are shared among the two LCNs as shown by the dotted lines.

Traffic between LCN 740 and LCN 760 is switched via the master switching element 730, the master switching element is connected to high speed trunks 728, that can carry traffic between the UIS and another node on the network if needed. Firewall 705 isolates and separates the master controller board 703 from the LCNs, firewall 705 is administered and configured by the operator of the master controller board 703. All control information ad network traffic destined to the master controller board must pass by firewall 705.

The invention could have several realizations. Referring to FIG. 6, in one implementation embodiment of the UIS, the master controller board 703, the master firewall 705 and the master switching element 730, could be integrated into one single hardware subsystem.

In a second embodiment of the invention, firewall 705 could be implemented in software and be running as an application on RTOS 706.

In a third embodiment of the invention and referring to FIG. 6, line boards 732a-c and traffic processor boards 731a-c could be realized on a single hardware board.

Furthermore, in a fourth implementation embodiment of the invention line boards 732a-c, traffic boards 731a-731c, master switching element 730, firewall 705 and master controller hardware board 703 could be implemented into one single hardware subsystem.

In a fifth implementation embodiment the master controller board 703 could be a separate hardware subsystem, the master switching element 730 could be another separate hardware subsystem, and the hardware elements of LCNs 740 and 760 be third and fourth and more hardware subsystem.

In a sixth embodiment of the invention, the master switching element 730 and the LCN, such as 740 and 760 could implemented on the same hardware board. Many other possible embodiments can exist and the invention does not limit the realization into any particular implementation.

As will be noticed to those skilled in the art, the implementation embodiments could vary. Accordingly, the scope of the patented subject should not be limited to any of the specific exemplary implementations discussed.

The preferred embodiment is illustrated in FIG. 5A, in which components 703 and 705 of FIG. 6 are integrated into a single hardware subsystem 729a and a backup subsystem 729b. Switching element 730 is a separate hardware subsystem and UIS 512 is realized using two master switching elements, a primary switching element 730a and a backup switching element 730b. A number of traffic processor boards 731 (731a-731i) for additional loads are realized as in FIG. 5A. Line board 732 is also a separate modular board as seen in FIG. 5A.

An LCN can span multiple hardware bards or subsystems and dynamically add, modify or delete hardware resources to a logical communication node in an adaptive manner.

The master switching element 730 and the local switching elements 556 (556a and 556b in FIG. 5D) are high speed, and low latency, they could be realized as optical or electrical switches and could be reconfigurable or static.

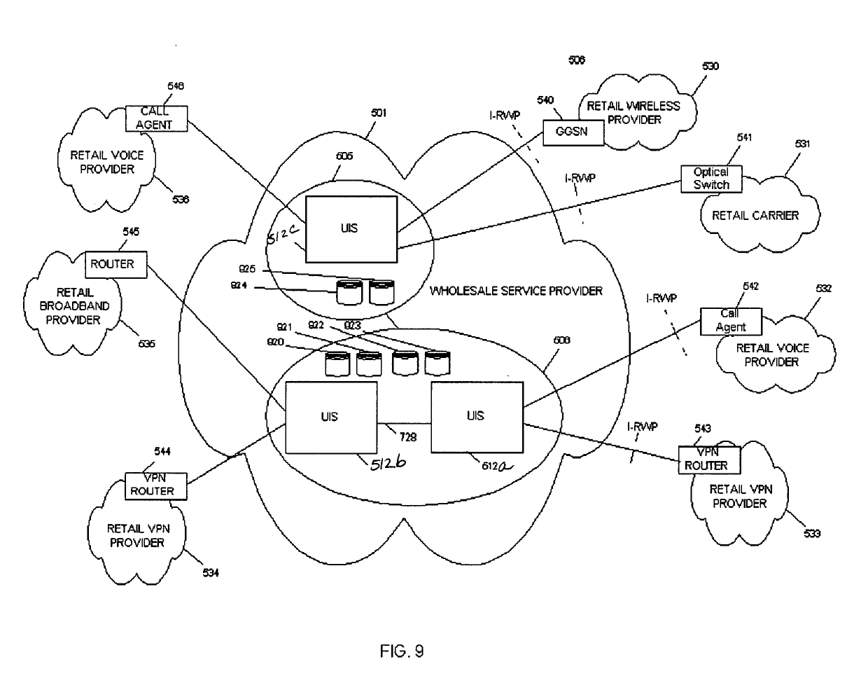

The system can be realized by a plurality of nodes 512 installed in a network connected to one another, and to other prior art nodes on the network such as IP routers, ATM switches, voice switches, optical switches and other IP aware nodes. UISs 512 will be connected to one another using the high speed trunk links 728 shown in FIG. 9.

In one configuration embodiment of the system, storage device 706 could host registries of network control and resource information on the apparatus. In a second configuration embodiment these registries could be hosted on a server on the network connected to UIS 512.

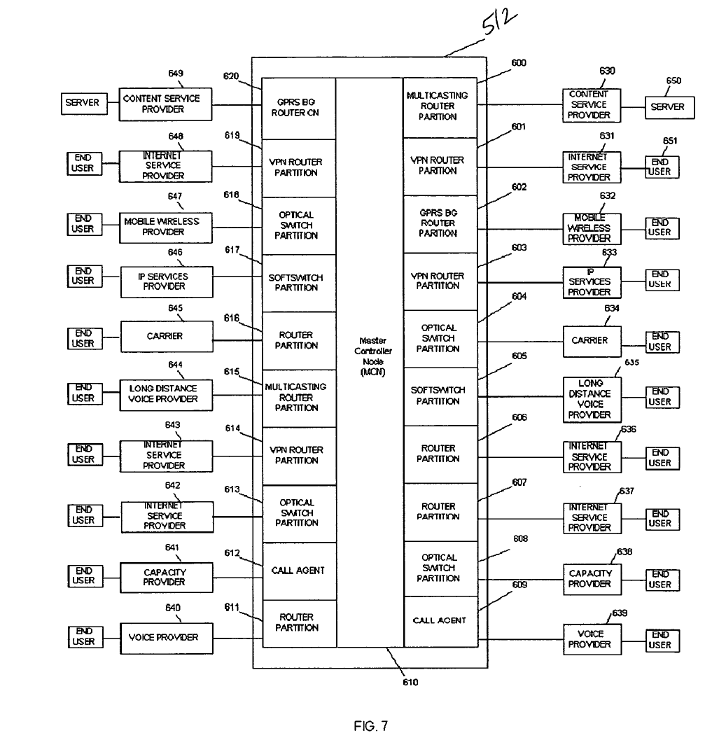

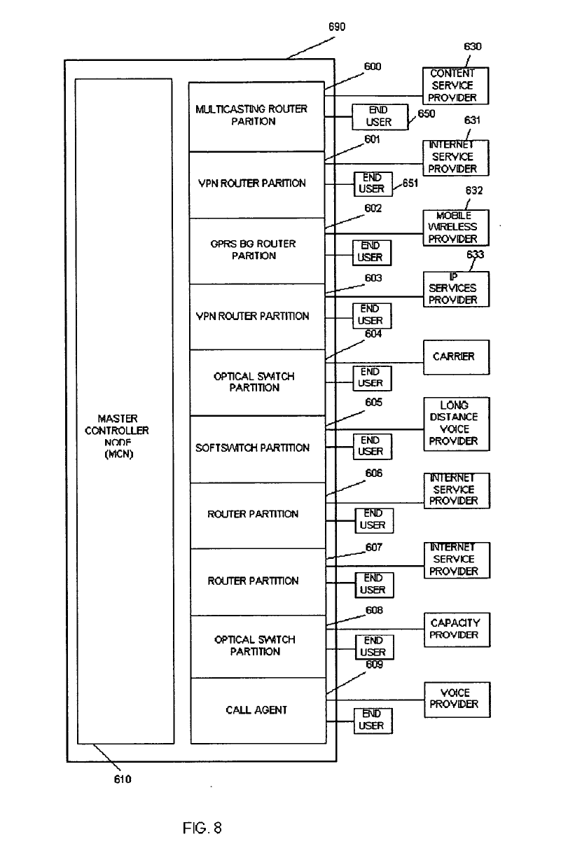

Two exemplary scenarios are provided which illustrate the operation of the invention. In the first exemplary scenario, the invention is applied to a NAP service and is illustrated in FIG. 7. In the second exemplary scenario the invention is applied to a POP service and is illustrated in FIG. 8.

FIG. 7 illustrates an exemplary configuration embodiment of the invention where UIS node 512 is partitioned into several partitions 600-620. Partition 610 is the MCN of UIS 512 and is operated by the NAP operator, who could be considered a wholesaler. Partitions 600-609 and 611-620 are leased by RSP 630-649, respectively. Each partition could be configured to provide one or more functions. For example, partition 600 is configured as a multicast router hence it could provide multicasting functionality and packet routing and forwarding.

In the case of a NAP application, as shown in FIG. 7, UIS 512 would be operated by the NAP operator which is considered a wholesaler, or the wholesale division of a retail service provider. The wholesaler configures the MCN by enabling and configuring main global services such as IP routing protocols, management protocols, addressing and configuration of management interfaces, storage area, firewall devices and signaling stacks to be used by the UIS.

The wholesaler then partitions the device into a number of LCNs based on the number of retailers the wholesaler has contracts with. These LCNs could be created at once, or one at a time. Referring to FIG. 6, the master controller board 703 is used by the wholesaler to configure the UIS and all LCNs, in this case 740 and 760, in addition to the management of the software and hardware subsystems of the UIS. The wholesaler connects to the master controller board 729 using the master controller port on interface 714. Each LCN is a separate entity, in the case of LCN 740 for example it comprises hardware resources available on line board 732a and traffic processor board 731a, in addition to a subset of hardware resources available on line board 732b and traffic processor board 731b. The wholesaler configures the MCN firewall 705 such that the main controller is secure, private and separate from LCNs configured on the UIS, and to secure and privatize partition 740 from other partitions as 760.

Referring to FIG. 6, RSP 532 and 533 are connected to UIS 512. RSPs could be connected to the UIS at only one port such as the case of RSP 533 or at multiple ports such as the case of 532. RSPs 532 and 533 could be any type of retail provider, examples of types of RSPs are wireless service providers, Internet service providers (ISPs), Competitive Local Exchange Carriers (CLECs), Regional Bell Operating Companies (RBOCs), long distance voice carriers, and others. Each of the LCNs could be configured to perform a variety of functions as required by the RSP.

Referring to FIG. 6 the UIS is designed such that the number of traffic ports located at the physical in-band interface I-RWP1 and I-RWP2 are equal to or more than the number of retail service providers running traffic. For example, the number of ports to which retail providers are connected to is N, while the number of active retail providers sending or receiving traffic is M, where M<N. These additional ports are used in a standby mode and are used for cases where a retail services provider has a contract with the wholesaler to request on demand additional physical capacity through the UIS. In such case the standby port and other associated hardware resources get added to the retailer's LCN, allowing the RSP to save and cut costs of unused resources especially in the long-haul or regional portion of the network.

FIG. 8 illustrates an exemplary configuration embodiment of the invention for the case of a POP. In the case of a POP application and referring to FIG. 8, the operator of the UIS could be a wholesale service provider who manages the UIS, or could be a retail service provider that has a POP and is willing to share resources with other retail service providers. In the case where the UIS operator is a retail provider and the other service providers are also retail service providers there is a possibility that the UIS operator and LCN users are competitors and hence extra security measures must be taken, in such case the master controller is configured to have access only to available resources on the UIS which are not assigned to a configured LCN, unlike the case of a NAP where the master controller had full access to all resources on the UIS, and could monitor and collect statistics of said resources.

FIG. 9 illustrates an exemplary network configuration where a plurality of UIS nodes 512a-512c are interconnected and located in 2 POPs 505, 506. Both POPs 505, 506 are managed and operated by WSP 501, which provides a number of services to a plurality of RSPs 530-536. POP 506 hosts a contracting application 920, a services profile database 921, a resource inventory database 922, a policy server 923, and a security server 924. UIS nodes 512a-512c could be connected in a star, ring, mesh, hub and spoke or bus topology using interface 728 shown in FIG. 5D.

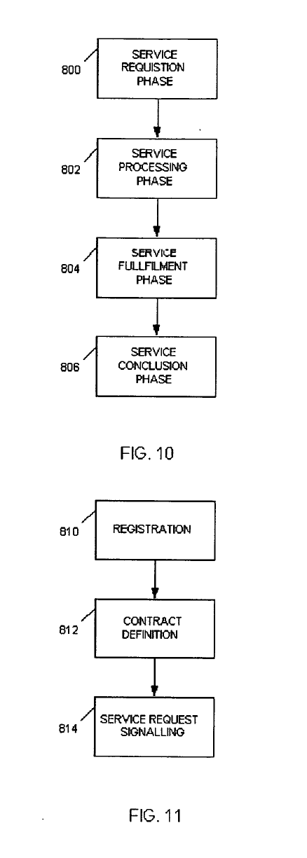

FIG. 10 depicts the general process and phases of interaction between the retail service provider connected to an UIS and the operator of an UIS as related to the invention. The interaction starts with the service requisition phase 800, followed by the service processing phase 802, followed by the service fulfillment phase 804 and finally the service conclusion phase 806.

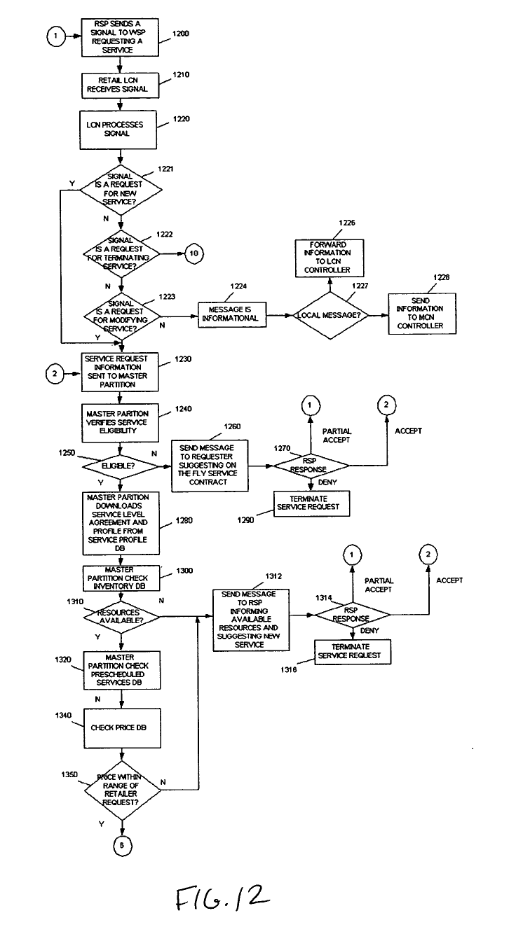

FIG. 11 shows the main processes of the service requisition phase. The service requisition phase 800 starts with the registration process 800 where the retail service provider registers itself and the services it requires from the operator of the UIS, with the UIS operator. The registration process 810 could be a manual and static process, for example using a telephone or sending an email to the UIS operator's sales department, a second example could be in person, having a representative from the retail service provider visit the sales department of the wholesaler and fill out an application. The registration process 810 could also be an electronic registration process using a web page and providing the registration software application running a registration server managed by the UIS operator service provider, with all the relevant information. In the preferred embodiment of this invention the registration process takes place by having the administrator of the RSP login using a GUI interface such as a web browser to the registration application hosted on the registration server administered by the WSP. The RSP administrator inputs the relevant information.

The registration process 810 involves providing the UIS operator with the business name of the retail service provider, the retail service provider bank account number and the routing number of the bank, the number of services requested, the categories of the services, types, quality and price range which the retailer will be willing to pay for each service defined in the application. Other information that might also be required but is not directly related to this invention could be information for a technical point of contact, business point of contact, street address, and other non relevant information to this invention.

The registration process 810 is followed by a contract definition process 812. The contract is generated by the UIS operator's contracting application 920 in FIG. 9, the contract is generated based on the information that the retail service provider provides in the registration process, unless the retail service provider elects not to generate an automatic contract. The contract is then delivered to the retailer using a number of possible mechanisms such as a feedback message received in the form of a fax, email reply, or a hard copy hand delivered contract, the mechanism will depend on the option selected by the retailer when registering. The contract contains information such as the services that the retail service provider is eligible to receive, the price range for these services, and instructions for connecting to the UIS node. In the preferred embodiment of the invention contract is generated and delivered electronically to the RSP administrator in real-time.

Included in the generated contract is information regarding the UIS that the RSP is supposed to connect to, and the ports to be used by the RSP. Referring to FIG. 6, and process 812 in FIG. 11, the retail service provider 532 receives instructions about ports to connect to for configuring the partition and for traffic flow, such as information about the management port on interface 714 to use for configuring the retailer's LCN, information about the LCN identification, and the number and location of traffic ports on interface I-RWP1 that are part of the LCN, on UIS 512.

Depending on the contract generated the RSP may not pay the operator of the UIS at this stage except for the cost of leasing management ports through interface 714, and for the cost of leasing traffic ports on interface I-RWP1. Retail service provider 532 configures LCN 740 by through using one of the management ports connected to interface 714.

The service requested by a retail service provider from the UIS operator will differ depending on the scenario in which the UIS is used. There are also different types of service requests, the first type disclosed in this invention is a LCN service enabler request, which is sent by an RSP administrator to a WSP administrator to enable a LCN and define its main functionality. This service request is typically initiated upon the initial provisioning of the LCN. A second type of service request disclosed in this invention is the network service request, this is message initiated by a network protocol requesting some action to be taken by the UIS to achieve a network function.

Referring to FIGS. 7 and 9, in the case of a NAP, MMR or voice telecom hotel service the retailer will require the need to peer and interconnect with other service providers. Hence the RSP OSS system will send an LCN service enabler request message to services profile database 921 administered by UIS operator 501, defining the service required. This message could be initiated manually by an administrator at the RSP or dynamically by the OSS systems, or a node on the RSPs network using a protocol such as COPS, XML or other similar protocols. The services database 921 administered by the WSP checks to validate the request against the contract held with the RSP by contacting the contracts database 920 and the security database 924, performing an authorization process. If the RSP is found eligible the resource inventory database 922 checks for the availability of resources on the WSP UIS and network to support the said request. This process is performed only once upon the initial provisioning of the LCN by the RSP and upon requesting a new type of service support, for example the ability to have the LCN function as a packet voice switch or an IP router. Once the RSP has received validation and other resources on the network have been identified to support this new service type by the WSP, the MCN of the UIS to which the RSP LCN is provisioned on, downloads configuration information to the LCN to support the new function type.

Referring to FIG. 6 and FIG. 11, the service request process 814 in phase 800 starts with an end node on network 532 requiring the need to transmit and receive information with and from another end node located on network 533, hence the need for RSP 532 and RSP 533 to peer. The end user nodes could be a fixed workstation of subscriber in a corporate network, a mobile roaming PDA or an application running on a server. In all cases the end node is a packet aware node. A few examples of signaling protocols that could be used by the network nodes to request for this service are RSVP, SIP and MPLS.

The network edge node (not shown) on service provider 532 network is connected to UIS 512 at LCN 740 using ports on interface I-RWP1. LCN 740 is administered by retail service provider 532 and leased from the operator of UIS 512. Upon the completion of the authorization process and the contract validation process, LCN 740 receives and sends configuration information such as network topology information to and from master controller board 703. LCN 740 had also been already receiving topology information from other border nodes on retail service provider 532.

The MCN includes the master controller board 703 of UIS 512, and supports a number of different integrated functions acting as an open interconnection of hardware and software modules that dictate call and flow control, signaling, protocol mediation and service creation within a converged network. The MCN is the integration of the control planes of an IP router, an optical switch, a multimedia softswitch, and a packet service creation switch.

The UIS and the neighboring nodes in the WSP network and the RSP network such as 532 and 533 send out discovery messages, these messages allow all nodes on the network to discover the network topology, service types supported, quality, and availability of other nodes. The discovery protocols allows UIS 512 to build a neighbor connectivity database, identifying each neighbor and the interface to which it is connected to, in addition to many other attributes about the link connecting the UIS to the neighbor such as the cost of the link, the quality, bandwidth and other attributes defining the link. Examples of such protocols are IP routing protocols, LMP and other similar protocols.

The MCN builds routing tables by receiving route advertisements from neighboring master controllers on other UISs and logical partitions on the same UIS using protocols such as RIP, OSPF, IS-IS and BGP. The MCN also learns about topology changes and physical routing using protocols such as O-UNI, LMP and GMPLS. In addition the master partition can learn about the topology of a voice network by supporting protocols such as SIP, MEGACO and H.248. The MCN has stacks for IP routing voice signaling and optical switching. Through the use of protocols such as SIP, MPLS, GMPLS, the master partition can also provide service creation control and management, and also receives provisioning information from policy servers on the WSP network such as 923.

In the preferred embodiment of the invention master controller board 703 does not take part in the actual forwarding and switching of traffic, although it could be technically feasible. Master controller board 703 learns information from neighboring LCNs and other remote MCNs. The operator of the UIS configures policies that are based on the information provided by the RSP upon registration and on contracts between a retailer and the operator of node 512, the MCN downloads policy and configuration information to the LCNs. This downloaded information allows the LCNs to decide how to forward and switch any traffic received or sent on it. The RSP can configure the LCN to define methods of processing traffic received or sent by the LCN. For example, retail service provider 532 can configure LCN 740 to support 8 quality of service queues throughout LCN 740, while retail service operator 533 can configure LCN 760 to support only 4 quality of service queues. The retail service provider has the ability to configure and customize the traffic processing and handling functions, and the LCN forwards and switches the said traffic based on control information received from the network and MCN.

In a preferred configuration embodiment a retail service provider will configure a LCN to support the functions and services it offers its subscribers. Referring to the exemplary case of FIG. 7, retail content service provider 630, configures LCN 600 on UIS 512 as a multicasting capable IP router and retail internet provider 631 which offers VPN services configures LCN 601 on UIS 512 as a VPN capable router. Other LCNs are configured as noticed in FIG. 7 as well.

To one skilled in the art it can be noticed that any single LCN could support a plurality of functions, for example a voice signaling gateway and an IP router peering node, and an optical switch, or any other combination that supports the business needs of the retail service provider. This is due to the platform architecture of the UIS as illustrated in FIGS. 5 and 6, and the ability to support IP and optical signaling and control protocols.

Referring to FIG. 7, in the case of a NAP configuration, the service request could be a request for extending a VPN service or trunking voice calls between a number of RSPs connected to the UIS, or interconnection of a video session, or any other service that is based on IP or optical signaling or control protocols. QoS exchange services as well is another example of services offered among RSPs connected to an UIS in a NAP mode. Generally speaking an MCN can offer a plurality of LCNs on the same UIS the ability to interconnect or exchange packet based services, such as VPNs, QoS, trunking, media handling, routing, multicasting or any other electrical or optical packet based service.

Referring to FIG. 8, in the case of a shared POP, the service processing is simpler, the LCN service enabler request is the same as that of the case of the NAP. The network service request is simpler since there is no peering, exchange or interconnection between the LCN and other LCNs, but rather the LCN is operating as a POP node on the RSP network aggregating traffic from the subscribers and sending the aggregated traffic to the RSP network backbone. The LCN could be configured by the RSP to perform the functions that the RSP requires to support the services sold in the local territory in which the POP is located. Examples of such services could be broadband access, IP services selection, VPNs and many others.

Referring to FIG. 6 and FIG. 10, LCN 740 receives the service request signal, which could be in the form of an IP routing update, a SIP message, an OIF message, RSVP signal, GMPLS signal or any other open standard IP or optical protocol. LCN 740 processes the message or signal and forwards the processed information to master controller board 703. Since LCN 740 has been configured by the RSP to support and provide the service requested by the Retail SP network, the LCN can add information about the service requested before forwarding it to master controller board 703. The master partition having a database of configured LCNs, is able to locate a second LCN such as 760, configured and administered by a second RSP such as 533 on the same UIS 512 that can provide the required services by the first RSP 532.

If an LCN is located on the same UIS node and the said LCN can satisfy the service request, quality attributes, cost requirements and other requirements such as the contractual, commercial, service and technical requirements of a second RSP, then the MCN interconnects both the first LCN and the second LCN, by controlling the master switching element 730.

If the master controller is unable to locate a LCN on the same UIS node that satisfies the requirements and other requirements of the requesting LCN, then the master controller board signals other master controller boards located on other UIS nodes on the network. The master controller then interconnects the first local LCN and the second remote LCN located on a remote UIS, this said remote LCN is configured and located on the said remote UIS which is connected to the first local UIS through the network using direct high speed trunk links 728. The first local UIS master controller board will have access to capability information of other remote UIS on the network through the use of topology and capability protocols exchanged between the UISs available on the network.

If the local master controller is unable to locate any other LCNs on other UIS nodes, then a series of negotiations takes place between the wholesale SP and the retail service provider to provide a different service at a different price. This takes place by the master controller board sending a response to the wholesaler OSS application, the OSS application then in return communicates with the RSPs OSS system and then a new network service request is initiated by the RSPs network nodes, or OSS system directly.

If the modified service request is sent by the RSP via network nodes, the master controller board analyzes receives the request and analyzes it and might process the information included in the service request, to verify the eligibility of the retail service provider to receive the requested service, or the master controller board will forward request to the WSP OSS for verification. The service request received by the master controller board will contain a number of fields the most important is the retail service provider ID, which could be in the form of a domain ID, source address, network ID, or other fields identifying the retail service provider. The master controller board performs this verification by accessing a retail service provider service profile database which could be hosted and stored on the master controller board stored on fixed storage or in memory, or located on the wholesaler's network in the same POP or remotely in another POP or data center, or in the WSP OCC database. Some form of authentication could also take place between the retail service provider and the wholesale service provider to prevent spoofing and to enhance security. Examples of service requests are IP protocols messages, OIF signaling, GMPLS signaling, MPLS signaling, SIP signaling, RSVP signaling, ATM UNI signaling and other similar protocols.

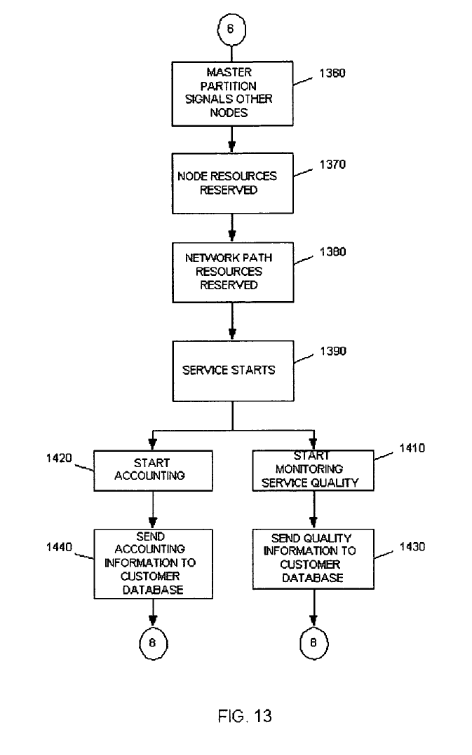

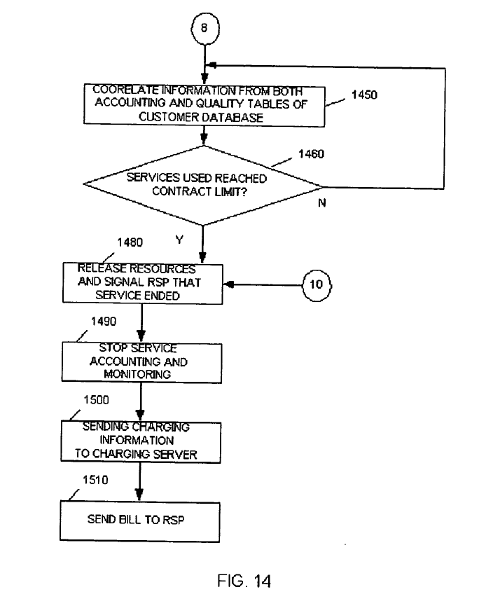

FIG. 12 illustrates the steps involved in processing service requests. It starts with step 1210 where the RSP LCN receiving a signal or message from a downstream node on the RSPs network. The LCN then processes the signal in step 1220 and identifies the type of the signal in step 1221. If the signal is a new service request then it is forwarded to the master controller board in step 1230. If the signal is a request to terminate a service then step 1480 in FIG. 14 occurs. The signal might not be a service termination request, but a service modification request as indicated in step 1223. If that is the case then the signal is forwarded to the master controller board for verification and resource allocation as seen in step 1230. The received signal at the LCN could be a simple informational signal, and in that case it is stored either in the LCN or the master controller board depending on its scope and severity, as shown in steps 1226 and 1228, respectively.

When the master controller board receives signaling requests, the said signaling requests are analyzed as shown in step 1240 and the master controller board contacts the contract application and customer profile database to verify the eligibility of the said service as shown in step 1250. If RSP is not eligible to provision the requested service the master controller board sends a message in step 1260 to the contracting application and database 920, which in return contacts the RSPs OSS application suggesting an on-the-fly service contract, if the RSP accepts the generated contract the master controller board provisions the service otherwise the request is denied and the service request terminated. When RSP is found eligible to receive requested service the master controller board downloads the service profile and attributes to the LCNs involved in provisioning the service in step 1280. The master controller board then checks the inventory database in step 1300 for available resources, if resources are not available locally on the UIS, the master controller board communicates with other master controller boards on other remote UIS. If no resources are found available on other nodes in the network a message is sent to the RSP suggesting a modified service request as shown in step 1312, the RSP might decide to accept the modified service request and at that point would send an acknowledgment to the master controller board which would then process the request as shown in step 1314 and 1230. The RSP can also partially accept the WSP suggestion and send a response back as shown in outcome 1 of step 1314.

The pricing database is accessed in step 1340 to ensure that the prices for services offered meet the RSPs contract and are within the range of acceptance. If not then the WSP signals the RSP with a suggestion of a modified service and/or price as illustrated in step 1312.

Fulfilling the service depends on the type of service. Generally speaking after all signaling information is processed, traffic will start flowing based on routing, forwarding and other policy information. The upstream traffic will leave the RSP network, for example, 630 in FIG. 7 towards LCN 600 on UIS 512 and then it will be forwarded by UIS 512 to another RSP such as mobile wireless provider 647 which requires to access content from content service provider 630 for the subscribers of mobile wireless provider 647. This invention provides an architecture and foundation for the fulfillment of many inter-provider packet based services and transactions.

FIG. 13 illustrates the basic steps in fulfilling a service. The process typically starts as shown in step 1360 with the master controller board signaling other nodes on the network and other LCNs on the same UIS that will be taking part in serving the request. UIS resources are then reserved as noticed in step 1370. This is then followed by a reservation or signaling of network resources in step 1380. The network service takes place and monitoring of the service and accounting of the service and associated parameters takes place in steps 1410 and 1420, respectively. Collected information is then sent to a data warehouse where information can be extracted and correlated to customer contracts, historical information and other service related information to create charging records.

FIG. 14 illustrates the main exemplary steps in the service conclusion phase. It starts with step 1450 where the information collected by the monitoring and accounting processes in steps 1410 and 1420 is sent to OSS servers 920-929. A service status monitor on the service profile application server and if the applications detect that a service limit has been reached a signal is sent to the network nodes to terminate the service and release resources used as shown in step 1480, or the OSS system of the RSP could send a terminate service request to the OSS system of the WSP. The detection of an end of service could be due to a manual input from a user interface such as an interactive voice response system, or could be based on a network status such as reaching a certain number of transmitted bytes of data. After resources are released in step 1480, monitoring and accounting of the service stops in step 1490, and all information for the specific service request is sent to the charging server and other servers involved in processing the information as indicated in step 1500. The RSP is then finally billed as noticed in step 1510.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

We claim:

1. A packet services node within a telecommunications network, comprising:
a logical master communications node associated with a service provider and capable of being dynamically configured in a customized manner by the service provider; and
common resources, a portion of said common resources being dedicated to said logical communications node and capable of being configured by the service provider.

2. The packet services node of claim 1, wherein the portion of said common resources is capable of being dynamically and customarily reconfigured and allocated to said logical communications node.

3. The packet services node of claim 1, wherein said common resources include switch fabric.

4. The packet services node of claim 1, wherein said common resources include a line board.

5. The packet services node of claim 1, wherein the line board includes optical and electrical signal processing and handling components, optical and electrical signal processing and the handling component including at least one of such as transceivers optical splitters, optical/electrical converters, optical delays, electronic controllers, wavelength converters, and a high speed optical/electrical switching element

6. The packet services node of claim 1, wherein said common resources include traffic processor boards.

7. The packet services node of claim 1, wherein said common resources include software resources

8. The packet services node of claim 1, further comprising:
an additional logical communications node associated with an additional service provider, said additional logical communications node being capable of being dynamically configured in a customized manner by the additional service provider; and
an additional portion of said common resources dedicated to said additional logical communications node and capable of being configured by the additional service provider.

9. The packet services node of claim 6, further comprising:
a firewall providing private and secure separation between said logical communications node and said additional logical communications node.

10. The packet services node of claim 6, wherein said additional logical communications node is a master communications node and the additional service provider is an operator of the packet services node, the master communications node being configured to manage and allocate said common resources to said logical communications node.

11. The packet services node of claim 1, wherein the packet services node is an internet protocol (IP)-based router or switch, optical switch with IP awareness or a voice softswitch.

12. The packet services node of claim 11, wherein said logical communications node operates as a separate packet services node.

13. A system for sharing and optimizing resources between service providers within a telecommunications network, comprising:
a first service provider capable of providing telecommunications services to end users; and
a unified and integrated switch within the telecommunications network and having a physical interface to said first service provider, said unified and integrated switch including a first logical communications node associated with said first service provider, said first logical communications node having a first portion of common resources dedicated thereto, the first portion of the common resources being configured by said first service provider.

14. The system of claim 13, wherein the first portion of the common resources is dynamically and customarily reconfigured and allocated to the first logical communications node by said first service provider.

15. The system of claim 13, further comprising:
a second service provider, said unified and integrated switch including a second logical communications node associated with said second service provider, the second logical communications node having a second portion of the common resources dedicated thereto that is configured by said second service provider.

16. The system of claim 15, wherein the second logical communications node is a master communications node and said second service provider is an operator of said unified and integrated switch, said master communications node being configured to manage and allocate the common resources to the first logical communications node.

17. The system of claim 16, wherein the master communications node is connected to additional master communications nodes on respective additional unified and integrated switches on the telecommunications network.

18. The system of claim 15, wherein said unified and integrated switch further includes a logical interface between the first logical communications node and the second logical communications node.

19. A method for sharing and optimizing resources of a packet services node within a telecommunications network between service providers, comprising:
receiving a service request from a service provider, said service request including configuration information for a logical communications node associated with the service provider within the packet services node;
allocating a portion of common resources within the packet services node to the logical communications node;
configuring the portion of the common resources allocated to the logical communications node using the configuration information; and
providing a service to the service provider using the logical communications node within the packet services node.

20. The method of claim 19, wherein said receiving further comprises:
receiving a service request to establish the logical communications node associated with the service provider within the packet services node.

21. The method of claim 19, wherein said receiving further comprises:
receiving a service request to establish a new service for the logical communications node associated with the service provider within the packet services node.

22. The method of claim 19, wherein said allocating and said configuring are performed statically.

23. The method of claim 19, wherein said allocating and configuring are performed dynamically.
